(19) United States
(12) Patent Application Publication
(10) Pub. No.: US 2026/0109542 A1
(43) Pub. Date: Apr. 23, 2026

(54) ORDER-BASED PICKING TYPE DETERMINATION APPARATUS

(71) Applicant: Twinny Co., Ltd., Daejeon (KR)

(72) Inventor: Seol Hee JEON, Daejeon (KR)

(73) Assignee: Twinny Co., Ltd., Daejeon (KR)

(21) Appl. No.: 19/146,910

(22) PCT Filed: Apr. 23, 2025
(86) PCT No.: PCT/KR2025/005492

§ 371 Date: Jul. 9, 2025

(30) Foreign Application Priority Data
Apr. 29, 2024 (KR) 10-2024-0057229

(51) Int. Cl. B65G 1/137; B65G 1/04

(52) U.S. Cl. CPC B65G 1/1375; B65G 1/0492

(57) ABSTRACT

An order-based picking type determination apparatus includes a memory configured to store at least one instruction for determining a picking type based on an order and a plurality of orders, and a processor configured to execute the at least one instruction stored in the memory. The processor is configured to retrieve the plurality of orders from the memory, select, from among the retrieved orders, multiple-item-multiple-quantity orders having a plurality of item types, and determine a picking type for each of the multiple-item-multiple-quantity orders based on the item quantity of all item types included therein. By the order-based picking type determination apparatus, it is possible to distinguish between cases in which processing multiple multiple-item-multiple-quantity orders together is advantageous in terms of order processing efficiency and cases in which processing only a single multiple-item-multiple-quantity order is more advantageous. As a result, the efficiency of processing the customer's orders can be significantly improved.

### CROSS REFERENCE TO THE RELATED APPLICATIONS

This application is the national phase entry of International Application No. PCT/KR2025/005492, filed on Apr. 23, 2025, which is based upon and claims priority to Korean Patent Application No. 10-2024-0057229, filed on Apr. 29, 2024, the entire contents of which are incorporated herein by reference.

### TECHNICAL FIELD

The present disclosure relates to an order-based picking type determination apparatus.

### BACKGROUND

A product delivery service conducted online includes: a process in which an customer inputs an order through a user terminal; a process in which the order is transmitted online to a warehouse management server, and a picking worker picks the items included in the order from a logistics warehouse and transfers them to a packing table; a process in which a packing worker positioned at the packing table packs the transferred items according to each order; and a process in which a delivery person delivers the packed products to the customer.

Among such product delivery services, the process in which a picking worker picks the items included in the order from a logistics warehouse and transfers them to a packing table requires excessive time and effort when performed entirely manually, due to the large number of orders. Accordingly, in recent trends, systems have been established in which a picking worker loads the picked items onto an item transport robot, and the item transport robot transfers the loaded items to a packing table, thereby enabling faster and more convenient processing of the customer's orders.

The act of picking the items included in the customer's order from a logistics warehouse is referred to as order picking. The item transport robot autonomously navigates within the logistics warehouse to process the customer's order. In this process, the worker either moves together with the item transport robot or remains within a preset item picking zone in the warehouse. When the item transport robot arrives at the item picking zone, the worker picks the items included in the customer's order from the storage location in the warehouse and loads them onto the item transport robot.

In this case, if the picking worker unconditionally picks only the items included in a single order and loads them onto the item transport robot, the order processing efficiency inevitably becomes very low.

However, if the picking worker unconditionally picks the items included in multiple orders together and loads them onto the item transport robot, the travel path of the item transport robot may become excessively long in order to load all the items, which can instead lead to a decrease in order processing efficiency.

Moreover, if the picking worker unconditionally picks the items in multiple orders together and loads them onto the item transport robot, the items belonging to different orders may become mixed on the item transport robot. In such a case, the packing worker must go through a process of sorting the items by order before packing. However, if the items belonging to different orders are transferred to the packing table in a mixed state on the item transport robot, it takes an excessive amount of time for the packing worker to sort the items by order, which ultimately results in decreased order processing efficiency.

Meanwhile, Patent Document 1 below discloses a fulfillment service providing method that generates a picking list by analyzing order data collected from a seller terminal.

### RELATED ART DOCUMENT

### Patent Document

(Patent Document 1) Korean Patent Registration No. 10-2423340 (2022.07.18.)

### SUMMARY

### Technical Problem

The present disclosure is directed to providing a picking type determination apparatus capable of processing a customer's order with high efficiency.

However, the technical problem to be solved by the present disclosure is not limited to the aforementioned object alone, and other technical problems not explicitly mentioned will be clearly understood by those skilled in the art from the following description of the disclosure.

### Solution to Problem

An order-based picking type determination apparatus according to the first embodiment of the present disclosure may include a memory configured to store at least one instruction for determining a picking type based on an order and a plurality of orders, and a processor configured to execute the at least one instruction stored in the memory. The processor may be configured to retrieve the plurality of orders from the memory, select, from among the retrieved orders, multiple-item-multiple-quantity orders having a plurality of item types, and determine a picking type for each of the multiple-item-multiple-quantity orders based on the item quantity of all item types included therein.

In the first embodiment of the present disclosure, the processor may be configured to classify, among the multiple-item-multiple-quantity orders, those in which the quantity of all item types is less than or equal to a preset item quantity as first multiple-item-multiple-quantity orders, and determine a picking type for the first multiple-item-multiple-quantity orders as a picking type in which a picking worker picks items included in at least two of the first multiple-item-multiple-quantity orders together.

In the first embodiment of the present disclosure, the processor may be configured to determine, as a picking type for a first multiple-item-multiple-quantity order among the first multiple-item-multiple-quantity orders that includes only items placed in a preset item picking zone, a picking type in which a picking worker picks the items without distinguishing between orders during a picking operation.

In the first embodiment of the present disclosure, the processor may be configured to determine, as a picking type for a first multiple-item-multiple-quantity order among the first multiple-item-multiple-quantity orders that includes the same item types, a picking type in which a picking worker picks the items without distinguishing between orders during a picking operation.

In the first embodiment of the present disclosure, the processor may be configured to determine, as a picking type for a first multiple-item-multiple-quantity order among the first multiple-item-multiple-quantity orders that does not include only items placed in a preset item picking zone and does not include the same item types, a picking type in which a picking worker picks the items while distinguishing between orders during a picking operation.

In the first embodiment of the present disclosure, the processor may be configured to classify, among the multiple-item-multiple-quantity orders, those in which the quantity of all item types exceeds a preset item quantity as second multiple-item-multiple-quantity orders, and determine a picking type for the second multiple-item-multiple-quantity orders as a picking type in which a picking worker picks only the items included in a single second multiple-item-multiple-quantity order.

Meanwhile, an order-based picking type determination apparatus according to the second embodiment of the present disclosure may include a memory configured to store at least one instruction for determining a picking type based on an order and a plurality of orders, and a processor configured to execute the at least one instruction stored in the memory. The processor may be configured to retrieve the plurality of orders from the memory, select, from among the retrieved orders, multiple-item-multiple-quantity orders having a plurality of item types, and determine a picking type for each of the multiple-item-multiple-quantity orders based on the total volume of the items included therein.

In the second embodiment of the present disclosure, the processor may be configured to classify, among the multiple-item-multiple-quantity orders, those in which the total volume is less than or equal to a preset volume as first multiple-item-multiple-quantity orders, and determine a picking type for the first multiple-item-multiple-quantity orders as a picking type in which a picking worker picks items included in at least two of the first multiple-item-multiple-quantity orders together.

In the second embodiment of the present disclosure, the processor may be configured to determine, as a picking type for a first multiple-item-multiple-quantity order among the first multiple-item-multiple-quantity orders that includes only items placed in a preset item picking zone, a picking type in which a picking worker picks the items without distinguishing between orders during a picking operation.

In the second embodiment of the present disclosure, the processor may be configured to determine, as a picking type for a first multiple-item-multiple-quantity order among the first multiple-item-multiple-quantity orders that includes the same item types, a picking type in which a picking worker picks the items without distinguishing between orders during a picking operation.

In the second embodiment of the present disclosure, the processor may be configured to determine, as a picking type for a first multiple-item-multiple-quantity order among the first multiple-item-multiple-quantity orders that does not include only items placed in a preset item picking zone and does not include the same item types, a picking type in which a picking worker picks the items while distinguishing between orders during a picking operation.

In the second embodiment of the present disclosure, the processor may be configured to classify, among the multiple-item-multiple-quantity orders, those in which the total volume of the items exceeds a preset volume as second multiple-item-multiple-quantity orders, and determine a picking type for the second multiple-item-multiple-quantity orders as a picking type in which a picking worker picks only the items included in a single second multiple-item-multiple-quantity order.

### Advantageous Effects of Invention

According to the first embodiment of the present disclosure, the processor is configured to determine a picking type by taking into account the item quantity of all item types included in each of the multiple-item-multiple-quantity orders. Accordingly, depending on the item quantity of all item types included in a multiple-item-multiple-quantity order, it is possible to distinguish between a case in which processing a plurality of multiple-item-multiple-quantity orders (more specifically, a plurality of first multiple-item-multiple-quantity orders) together is advantageous in terms of order processing efficiency, and a case in which processing only a single multiple-item-multiple-quantity order (more specifically, a single second multiple-item-multiple-quantity order) is advantageous. As a result, flexible determination of the picking type based on the order becomes possible, and the efficiency of processing an customer's order can be significantly improved.

In addition, according to the first embodiment of the present disclosure, the processor is configured to determine the picking type for the first multiple-item-multiple-quantity orders, among the multiple-item-multiple-quantity orders, in which the quantity of all item types is less than or equal to a preset item quantity, as a picking type in which a picking worker picks items included in at least two of the first multiple-item-multiple-quantity orders together. Accordingly, since the picking worker picks items included in a plurality of first multiple-item-multiple-quantity orders together in a single picking operation, the efficiency of processing an customer's order can be significantly improved.

Meanwhile, according to a second embodiment of the present disclosure, the processor is configured to determine a picking type by taking into account the total volume of items included in each of the multiple-item-multiple-quantity orders. Accordingly, depending on the total item volume of items included in a multiple-item-multiple-quantity order, it is possible to distinguish between a case in which processing a plurality of multiple-item-multiple-quantity orders (more specifically, a plurality of first multiple-item-multiple-quantity orders) together is advantageous in terms of order processing efficiency, and a case in which processing only a single multiple-item-multiple-quantity order (more specifically, a single second multiple-item-multiple-quantity order) is advantageous. As a result, flexible determination of the picking type based on the order becomes possible, and the efficiency of processing an customer's order can be significantly improved.

In addition, according to the second embodiment of the present disclosure, the processor is configured to determine the picking type for the first multiple-item-multiple-quantity orders, among the multiple-item-multiple-quantity orders, in which the total volume of the items is less than or equal to a preset volume, as a picking type in which a picking worker picks items included in at least two of the first multiple-item-multiple-quantity orders together. Accordingly, since the picking worker picks items included in a plurality of first multiple-item-multiple-quantity orders together in a single picking operation, the efficiency of processing an customer's order can be significantly improved.

However, the effects of the present disclosure are not limited to those mentioned above, and other effects not mentioned will be clearly understood by those of ordinary skill in the art from the following description.

### BRIEF DESCRIPTION OF THE DRAWINGS

FIG. 1 is a diagram illustrating an order-based picking type determination apparatus of the present disclosure, together with a warehouse management server and an item transport robot.

FIG. 2 is an exemplary diagram of an item transport robot.

FIG. 3 is a first embodiment of a method by which the processor of FIG. 1 determines a picking type.

FIG. 4 is a diagram exemplarily illustrating an order consisting of one item type and one item quantity.

FIG. 5 is a diagram exemplarily illustrating an order consisting of one item type and a plurality of item quantities.

FIG. 6 is an exemplary diagram of an order including a plurality of item types.

FIG. 7 is another exemplary diagram of an order including a plurality of item types.

FIG. 8 is a diagram exemplarily illustrating storage locations of items A through I within a logistics warehouse.

FIG. 9 is a second embodiment of a method by which the processor of FIG. 1 determines a picking type.

### DETAILED DESCRIPTION OF THE EMBODIMENTS

### Cross-Reference to Related Application

This application claims priority to and the benefit of Korean Patent Application No. 10-2024-0057229, filed on Apr. 29, 2024, the disclosure of which is incorporated herein by reference in its entirety.

Hereinafter, the order-based picking type determination apparatus of the present disclosure will be described in detail with reference to the accompanying drawings. The accompanying drawings are provided merely by way of example to sufficiently convey the technical spirit of the present disclosure to those skilled in the art, and the present disclosure is not limited to the drawings set forth below but may be embodied in various other forms.

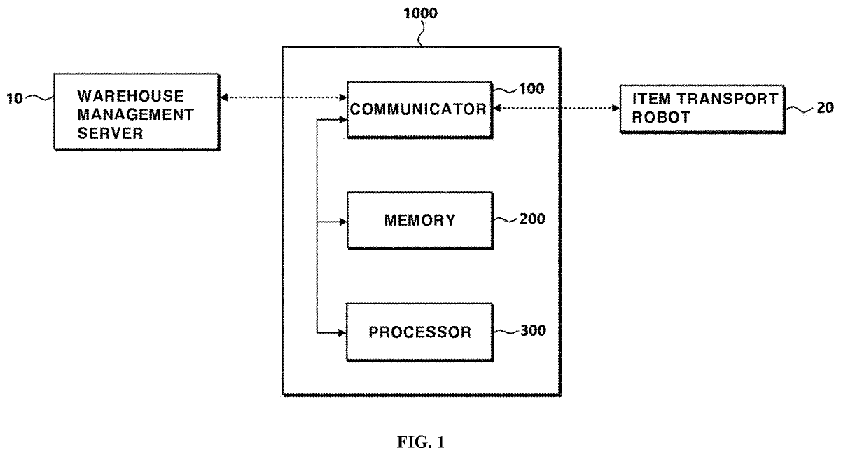

FIG. 1 is a diagram illustrating an order-based picking type determination apparatus 1000 of the present disclosure, together with a warehouse management server 10 and an item transport robot 20.

The warehouse management server 10 may be a server operated by an administrator of a logistics warehouse and may store storage location information of items kept in the logistics warehouse and orders input by customers online. The warehouse management server 10 may transmit the storage location information of items and the orders of the customers to a communicator 100 when requested by the communicator 100, which will be described later.

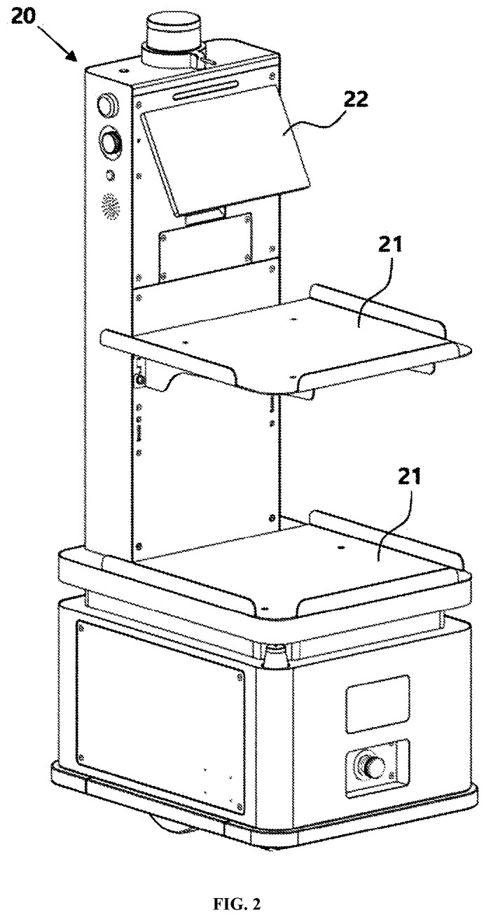

FIG. 2 is an exemplary diagram of an item transport robot 20. The item transport robot 20 may autonomously navigate within the logistics warehouse to load items included in an order of an customer. In this case, the autonomous navigation path of the item transport robot 20 may be based on a task command signal transmitted from a processor 300 to the item transport robot 20, based on storage location information of items and an order of an customer.

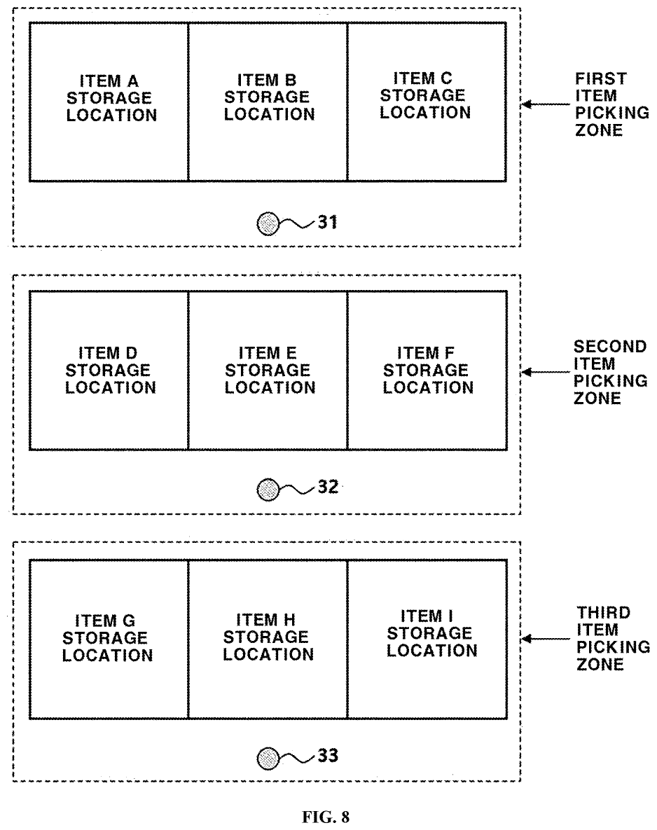

The item transport robot 20 may autonomously navigate within the logistics warehouse and be positioned at a station 31, 32, or 33, which will be described later (see FIG. 8). When the item transport robot 20 is positioned at the station 31, 32, or 33, a picking worker may pick items placed in an item picking zone and load them onto the item transport robot 20, and the item transport robot 20 may transport the loaded items to a packing table.

The item transport robot 20 may be provided with at least one mounting platform 21 and a display 22. A tote (not shown) for accommodating items may be placed on the mounting platform 21, and item information to be loaded onto the item transport robot 20 may be displayed on the display 22. A picking worker may check the item information displayed on the display 22 and pick items placed in an item picking zone to place them in the tote.

Meanwhile, the order-based picking type determination apparatus 1000 according to the present disclosure may include a memory 200 and a processor 300, and may further include a communicator 100.

The communicator 100 may receive storage location information of items and an order of an customer from the warehouse management server 10. Here, the order of the customer may be a plurality of orders, and accordingly, the communicator 100 may receive the plurality of orders from the warehouse management server 10. The communicator 100 may transmit the storage location information of the items and the plurality of orders of the customer to the memory 200.

The communicator 100 may transmit a task command signal output by the processor 300 and item information to be loaded onto the item transport robot 20 to the item transport robot 20. In this case, the item transport robot 20 may autonomously navigate within the logistics warehouse based on the task command signal, and the item information may be displayed on the display 22 of the item transport robot 20.

The communicator 100 may include at least one module of a wired communication module and a wireless communication module to perform communication with the warehouse management server 10 and the item transport robot 20.

The memory 200 may store at least one instruction for determining a picking type based on an order. Here, the at least one instruction may be stored in the memory 200 by a user of the picking type determination apparatus 1000.

The memory 200 may also store the storage location information of items and the plurality of orders of the customer transmitted by the communicator 100.

In another embodiment, the memory 200 may receive the storage location information of items and the plurality of orders of the customer from a user terminal of the picking type determination apparatus 1000, instead of receiving them from the communicator 100. More specifically, a user of the picking type determination apparatus 1000 may access the warehouse management server 10 through a terminal (not shown), such as a personally owned tablet PC or smartphone, download the storage location information of items and the plurality of orders of the customer from the warehouse management server 10, and store the storage location information of the items and the plurality of orders of the customer in the memory 200.

To perform such a storage function, the memory 200 may include a volatile or non-volatile storage medium. For example, the memory 200 may be implemented as, or include, a read only memory (ROM), a random access memory (RAM), an erasable programmable read only memory (EPROM), an electrically erasable programmable read-only memory (EEPROM), a flash memory, a static RAM (SRAM), a hard disk drive (HDD), or a solid state drive (SSD).

The processor 300 may determine a picking type based on an order by executing the at least one instruction stored in the memory 200. The instruction executed by the processor 300 is a computer-executable instruction. The processor 300 may be implemented as, or include, a micro processing unit (MPU), a central processing unit (CPU), a graphics processing unit (GPU), or a tensor processing unit (TPU) to execute the instruction. The communicator 100, the memory 200, and the processor 300 may be electrically connected to each other and may also be communicatively connected.

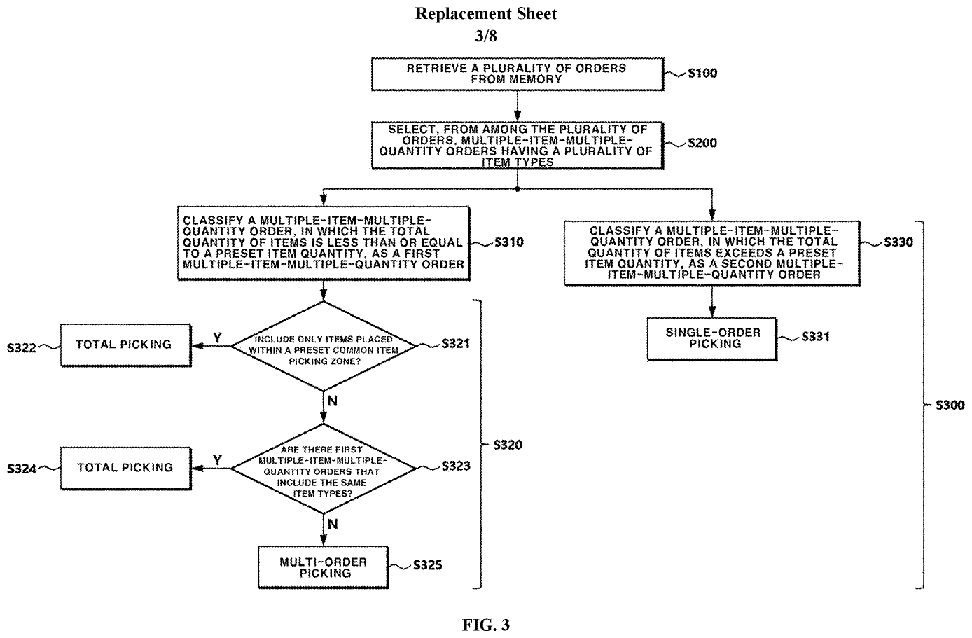

FIG. 3 is a first embodiment of a method by which the processor 300 of FIG. 1 determines a picking type.

According to the first embodiment of the present disclosure, the processor 300 may first retrieve a plurality of orders from the memory 200 (S100). More specifically, the processor 300 may request the plurality of orders from the memory 200, and in this case, the memory 200 may deliver the plurality of orders to the processor 300.

Each of the plurality of orders may include an item type and a quantity of items. The item type refers to an item ordered by the customer, and if at least any one of the item name, manufacturer, weight, or ingredients differs, it may be treated as a different item type. Item A, item B, item C, and the like, which will be described later, correspond to item types. The quantity of items refers to the number of the items, and quantities such as one, two, and three correspond to the quantity of items.

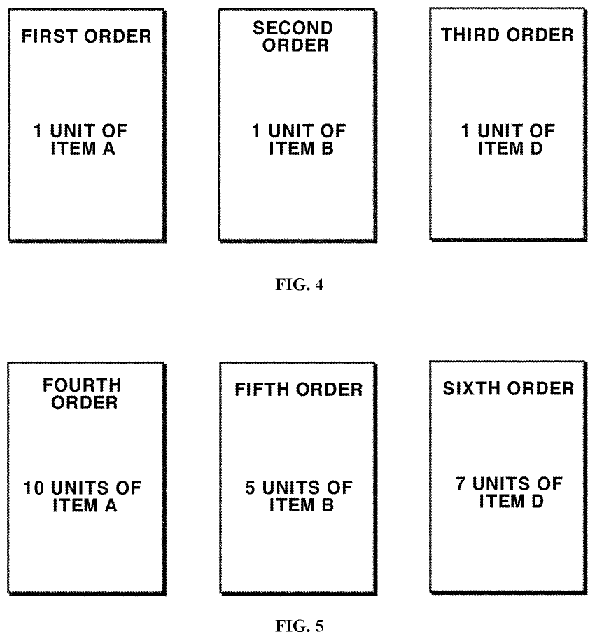

FIG. 4 is a diagram exemplarily illustrating an order consisting of one item type and one item quantity. As illustrated in FIG. 4, among the plurality of orders retrieved by the processor 300 from the memory 200, there may be orders in which the number of item types is one and the quantity of items is also one, such as a first order (one item A), a second order (one item B), and a third order (one item D). In the present specification, such orders will be referred to as “single-item-single-quantity orders.”FIG. 5 is a diagram exemplarily illustrating an order consisting of one item type and a plurality of item quantities. As illustrated in FIG. 5, among the plurality of orders retrieved by the processor 300 from the memory 200, there may be orders in which the item type is one but the quantity of items is multiple, such as a fourth order (ten units of item A), a fifth order (five units of item B), and a sixth order (seven units of item D). In the present specification, such orders will be referred to as “single-item-multiple-quantity orders.”

The single-item-single-quantity orders and the single-item-multiple-quantity orders each include only one item type. Accordingly, to process a single-item-single-quantity order or a single-item-multiple-quantity order, the picking worker simply needs to pick the item corresponding to each order from its storage location and load it onto the item transport robot 20.

For example, to process the first to third orders, the picking worker may pick one item A, one item B, and one item D from their respective storage locations, and then either load them onto the item transport robot 20 or carry them by hand to the packing table.

In addition, to process the fourth to sixth orders, the picking worker may pick item A (10 units), item B (5 units), and item D (7 units) from their respective storage locations, and then either load them onto the item transport robot 20 or carry them by hand to the packing table.

That is, in the case of single-item-single-quantity orders and single-item-multiple-quantity orders, since only one item type is included in each order, there is less need to devise measures for improving order processing efficiency compared to the case of multiple-item-multiple-quantity orders, which will be described later.

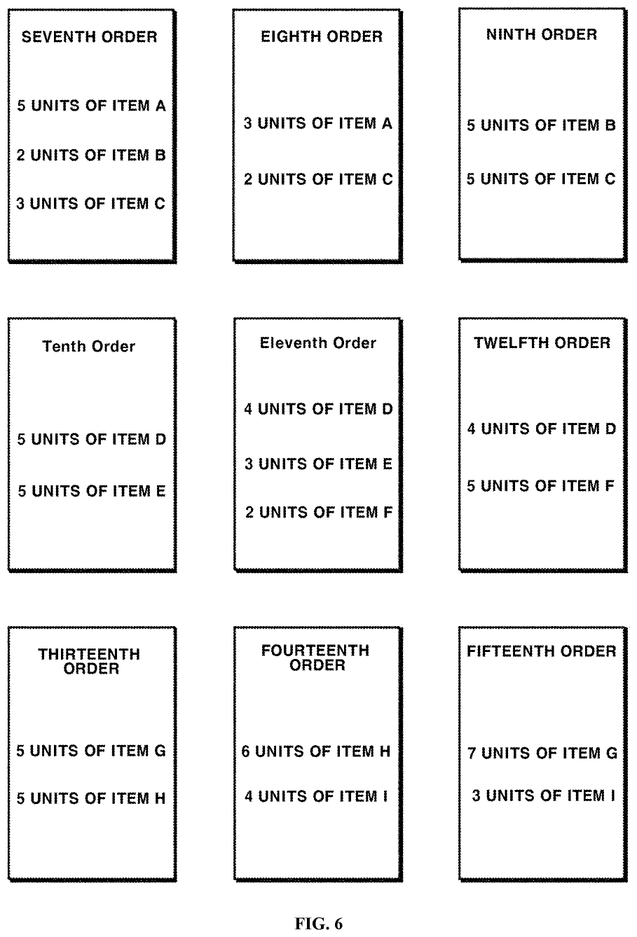

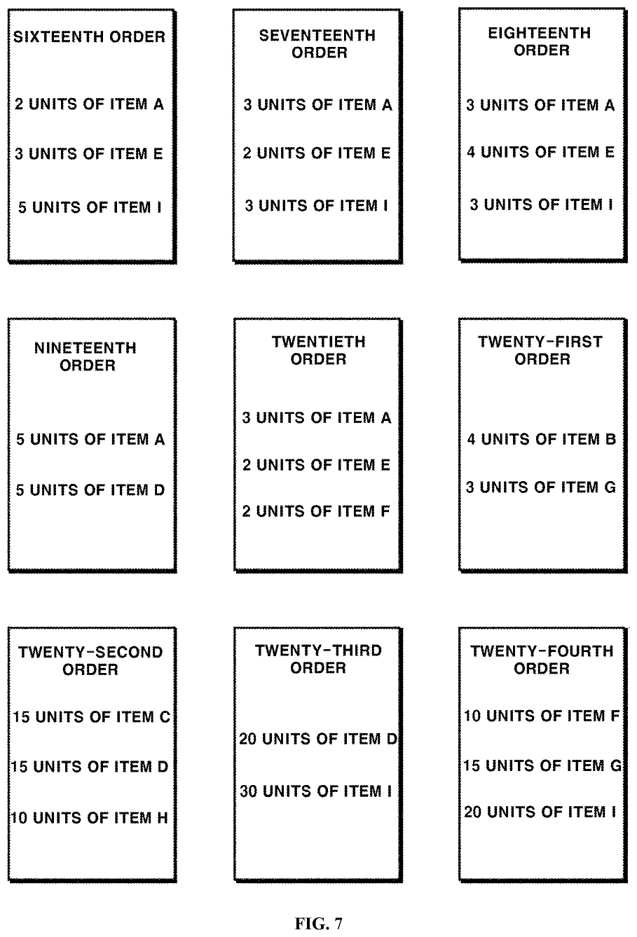

In contrast, FIG. 6 is an exemplary diagram of an order including a plurality of item types, and FIG. 7 is another exemplary diagram of an order including a plurality of item types.

As can be seen from FIGS. 6 and 7, among the plurality of orders retrieved by the processor 300 from the memory 200, there may be orders including a plurality of item types, such as seventh order to twenty-fourth order. In the present specification, such orders will be referred to as “multiple-item-multiple-quantity orders.”

Since multiple-item-multiple-quantity orders include various item types and quantities, there is a need to devise measures for efficiently processing multiple-item-multiple-quantity orders. Accordingly, it is desirable for the processor 300 to select, from among the plurality of orders retrieved from the memory 200 (for example, the first order to twenty-fourth order), the multiple-item-multiple-quantity orders having a plurality of item types (for example, the seventh order to twenty-fourth order) (S200).

Subsequently, the processor 300 may determine a picking type for each of the multiple-item-multiple-quantity orders selected in step S200 by considering the quantity of all item type included in the respective multiple-item-multiple-quantity order (S300).

For reference, after determining the picking type, the processor 300 may generate a picking list based on the picking type and may display item information, which is to be loaded onto the item transport robot 20, on a display 22 of the item transport robot 20 based on the picking list. That is, the present disclosure relates to a method of determining a picking type according to the characteristics of each order prior to generating a picking list.

Step S300 may be subdivided into step S310, step S320, and step S330.

First, in step S310, the processor 300 may classify, as first multiple-item-multiple-quantity orders, those among the multiple-item-multiple-quantity orders selected in step S200 in which the quantity of items for all item types included in each multiple-item-multiple-quantity order is less than or equal to a preset item quantity (S310). Here, the preset item quantity may be stored in the memory 200, and the processor 300 may retrieve the preset item quantity from the memory 200 when performing step S310. In the first embodiment of the present disclosure, the preset item quantity is described as being 30; however, the preset item quantity may be changed as desired.

In the examples of FIGS. 6 and 7, the processor 300 may classify, as first multiple-item-multiple-quantity orders, those multiple-item-multiple-quantity orders in which the quantity of items for all item types included in each order is less than or equal to a preset item quantity (e.g., 30), such as the seventh order to twenty-first order.

Subsequently, the processor 300 may determine the picking type of the first multiple-item-multiple-quantity orders, classified in step S310, as a picking type in which the picking worker picks items included in at least two of the first multiple-item-multiple-quantity orders together during the picking operation (S320). Here, the picking worker picking items included in at least two of the first multiple-item-multiple-quantity orders together means picking and collecting the items included in each of the at least two first multiple-item-multiple-quantity orders (for example, loading the items included in each of the at least two first multiple-item-multiple-quantity orders onto one or more item transport robots 20), and the items picked together in this manner may be transported together to the packing table.

If the item transport robot 20 is configured to load only the items included in a single order regardless of having sufficient space to accommodate more items on the item transport robot 20, the order processing efficiency may inevitably be very low.

Furthermore, if the quantity of items for all item types included in a certain multiple-item-multiple-quantity order is relatively small, and even when the item transport robot 20 loads the items included in the certain multiple-item-multiple-quantity order, the item transport robot 20 is still capable of sufficiently loading items included in another multiple-item-multiple-quantity order, it is desirable, in terms of improving order processing efficiency, for the item transport robot 20 to process two or more orders simultaneously.

For example, compared to the case where only the items included in the seventh order (i.e., five units of item A, two units of item B, and three units of item C) are loaded onto a single item transport robot 20, if the items included in the seventh order (i.e., five units of item A, two units of item B, and three units of item C), the eighth order (i.e., three units of item A and two units of item C), and the ninth order (i.e., five units of item B and five units of item C) are all loaded onto a single item transport robot 20, the single item transport robot 20 effectively processes three orders simultaneously, thereby significantly improving order processing efficiency. Accordingly, for each of the first multiple-item-multiple-quantity orders in which the quantity of all item types is less than or equal to a preset item quantity (for example, the seventh order to twenty-first order), it is desirable for the processor 300 to determine the picking type as a picking type in which the picking worker picks items included in at least two of the first multiple-item-multiple-quantity orders together during the picking operation.

Here, the picking type in which items included in at least two of the first multiple-item-multiple-quantity orders are picked together may include two types as described below.

The first type is a picking type in which the picking worker picks items without distinguishing between orders during the picking operation, and in the present specification, this picking type will be referred to as “total picking.” Here, that the picking worker picks items without distinguishing between orders during the picking operation means that the picking worker simply gathers the items included in the orders together, regardless of the orders.

Total picking has the advantage of relatively short picking time, since the picking worker picks items without distinguishing between orders during the picking operation. However, since the packing worker must sort the picked items by order at the packing table, total picking has the disadvantage of relatively longer packing time. For reference, the totally picked items may be transferred to a packing table while being accommodated in at least one tote without being sorted by order.

The second type is a picking type in which the picking worker picks items while distinguishing between orders during the picking operation, and in the present specification, this picking type will be referred to as “multi-order picking.” Here, that the picking worker picks items while distinguishing between orders during the picking operation means that the picking worker gathers the items included in the orders together, but collects them separately by order.

Multi-order picking has a disadvantage in that the picking time is relatively long because the picking worker must pick items while distinguishing between orders. However, since the packing worker does not need to sort the picked items by order at the packing table, there is an advantage in that the packing time is relatively short.

For reference, the multi-order picked items may be transferred to a packing table while being accommodated in different totes by order (for example, the items included in one order may be accommodated in a first tote, and the items included in another order may be accommodated in a second tote). Alternatively, a single tote may be divided into at least two or more sections, and in this case, the multi-order picked items may be accommodated in a single tote but transferred to a packing table while being accommodated in different sections within the tote (for example, the items included in one order may be accommodated in a first section of the tote, and the items included in another order may be accommodated in a second section of the tote).

The processor 300 may subdivide step S320 and determine a more suitable picking type between total picking and multi-order picking based on the characteristics of each order.

FIG. 8 is a diagram exemplarily illustrating storage locations of items A through I within a logistics warehouse.

Referring to FIG. 8, item A, item B, and item C are stored side by side in the logistics warehouse, and a first station 31 is mapped in front of item A, item B, and item C. The item transport robot 20 may autonomously navigate and be positioned at the first station 31 to load at least one of item A, item B, and item C. In this case, the picking worker may pick at least one of item A, item B, and item C in a first item picking zone and load it onto the item transport robot 20. That is, since item A, item B, and item C are arranged within a common item picking zone (i.e., the first item picking zone), when the item transport robot 20 is positioned at the first station 31, the picking worker can easily pick item A, item B, and item C and load them onto the item transport robot 20.

Item D, item E, and item F are stored side by side in the logistics warehouse, and a second station 32 is mapped in front of item D, item E, and item F. The item transport robot 20 may autonomously navigate and be positioned at the second station 32 to load at least one of item D, item E, and item F. In this case, the picking worker may pick at least one of item D, item E, and item F in a second item picking zone and load it onto the item transport robot 20. That is, since item D, item E, and item F are arranged within a common item picking zone (i.e., the second item picking zone), when the item transport robot 20 is positioned at the second station 32, the picking worker can easily pick item D, item E, and item F and load them onto the item transport robot 20.

In addition, item G, item H, and item I are stored side by side in the logistics warehouse, and a third station 33 is mapped in front of item G, item H, and item I. The item transport robot 20 may autonomously navigate and be positioned at the third station 33 to load at least one of item G, item H, and item I. In this case, the picking worker may pick at least one of item G, item H, and item I in a third item picking zone and load it onto the item transport robot 20. That is, since item G, item H, and item I are arranged within a common item picking zone (i.e., the third item picking zone), when the item transport robot 20 is positioned at the third station 33, the picking worker can easily pick item G, item H, and item I and load them onto the item transport robot 20.

Information on the item picking zones and information on the storage locations of the items may be pre-stored in the memory 200. Accordingly, the processor 300 may perform step S320 by loading the above-described information stored in the memory 200.

Referring again to FIG. 6, a seventh order includes item A, item B, and item C. That is, the seventh order includes only items that are arranged within the first item picking zone. In addition, an eighth order includes item A and item C, and a ninth order includes item B and item C. That is, the eighth order and the ninth order also include only items that are arranged within the first item picking zone.

A tenth order through a twelfth order include at least two types of items among item D, item E, and item F. That is, the tenth order through the twelfth order include only items that are arranged within the second item picking zone.

In addition, a thirteenth order through a fifteenth order include only two types of items among item G, item H, and item I. That is, the thirteenth order and the fifteenth order include only items that are arranged within the third item picking zone.

As such, when at least two first multiple-item-multiple-quantity orders include only items that are arranged within a preset item picking zone (for example, the first item picking zone, the second item picking zone, or the third item picking zone), the picking worker may pick the items arranged in the item picking zone together without distinguishing between the orders and load them onto the item transport robot 20. For example, when the item transport robot 20 is positioned at the first station 31, the picking worker may pick the items included in the seventh order through the ninth order—namely, a total of 8 units of item A, 7 units of item B, and 10 units of item C—together and load them onto the item transport robot 20.

As such, when the picking worker does not distinguish between orders during the picking operation, the picking time for the items can be significantly reduced. Of course, in this case, the packing worker must sort and pack the picked items by order (for example, by the seventh order, eighth order, and ninth order). However, since only the items arranged within a common item picking zone (for example, item A, item B, and item C) are transferred to the packing table by the item transport robot 20, it does not take much time for the packing worker to sort the picked items by order. That is, even when considering the time required for the packing worker to sort the picked items by order, the overall order processing time can be reduced in view of the reduced picking time for the picking worker.

In this regard, after step S310, the processor 300 may determine whether there is any first multiple-item-multiple-quantity order among the first multiple-item-multiple-quantity orders that includes only items arranged within a preset item picking zone (S321).

When the processor 300 determines in step S321 that there is a first multiple-item-multiple-quantity order among the first multiple-item-multiple-quantity orders that includes only items arranged within the preset item picking zone, the processor 300 may determine the picking type of such first multiple-item-multiple-quantity orders (for example, each of the seventh order through the fifteenth order) as total picking (S322), thereby improving the efficiency of order processing. Two or more of the first multiple-item-multiple-quantity orders may be determined as targets for total picking.

In contrast, when the processor 300 determines in step S321 that a first multiple-item-multiple-quantity order among the first multiple-item-multiple-quantity orders does not include only items arranged within the preset item picking zone (for example, the sixteenth order through the twenty-first order), the processor 300 may perform step S323 with respect to such orders.

Referring to FIG. 7 in connection with step S323, the sixteenth order through the eighteenth order each include the same item types, namely item A, item E, and item I. Here, the term “the same item types” means that the item types included in one order are not in a subset relationship with those in another order, but rather that the item types included in each order are exactly the same, as in the case of the sixteenth order through the eighteenth order.

To process the sixteenth order, the picking worker needs to pick two units of item A in the first item picking zone and load them onto the item transport robot 20, pick three units of item E in the second item picking zone and load them onto the item transport robot 20, and pick five units of item I in the third item picking zone and load them onto the item transport robot 20.

Subsequently, to process the seventeenth order, the picking worker needs to pick three units of item A in the first item picking zone and load them onto the item transport robot 20, pick two units of item E in the second item picking zone and load them onto the item transport robot 20, and pick three units of item I in the third item picking zone and load them onto the item transport robot 20.

Subsequently, to process the eighteenth order, the picking worker needs to pick three units of item A in the first item picking zone and load them onto the item transport robot 20, pick four units of item E in the second item picking zone and load them onto the item transport robot 20, and pick three units of item I in the third item picking zone and load them onto the item transport robot 20.

If the picking worker processes the sixteenth order through the eighteenth order in this manner, three picking operations are performed in each of the first item picking zone, second item picking zone, and third item picking zone, respectively. Considering the movement path of the item transport robot 20, this increases the order processing time and results in a decrease in order processing efficiency.

In contrast, when the picking worker picks a total of eight units of item A in the first item picking zone and loads them onto the item transport robot 20, picks a total of nine units of item E in the second item picking zone and loads them onto the item transport robot 20, and picks a total of eleven units of item I in the third item picking zone and loads them onto the item transport robot 20, the item transport robot 20 can process the sixteenth order through the eighteenth order simultaneously by being positioned at each of stations 31, 32, and 33 only once. That is, in this case, the order processing time is significantly reduced, thereby greatly improving the order processing efficiency.

In this case, the picking worker can pick the items included in the sixteenth order, seventeenth order, and eighteenth order from each item picking zone without necessarily distinguishing between the orders.

As described above, when the picking worker does not distinguish between orders during the picking operation, the picking time for the items can be significantly reduced. Of course, in this case, the packing worker must sort and pack the picked items by order (for example, by the sixteenth order, seventeenth order, and eighteenth order). However, since the same item types (for example, item A, item E, and item I) are transferred to the packing table, it does not take much time for the packing worker to sort the picked items by order. That is, even when considering the time required for the packing worker to sort the picked items by order, the overall order processing time can be reduced in view of the reduced picking time for the picking worker.

In this regard, after step S321 (or step S322), the processor 300 may determine whether there are two or more first multiple-item-multiple-quantity orders among the plurality of first multiple-item-multiple-quantity orders that include the same item types (S323).

When, as a result of the determination in step S323, there are two or more first multiple-item-multiple-quantity orders including the same item types, the processor 300 may determine the picking type of such two or more first multiple-item-multiple-quantity orders (e.g., the sixteenth order, seventeenth order, and eighteenth order, respectively) as total picking (S324), thereby improving order processing efficiency.

In contrast, when, as a result of the determination in step S323, the first multiple-item-multiple-quantity orders do not include the same item types, the processor 300 may determine the picking type of such orders as multi-order picking (S325).

For example, the nineteenth order through the twenty-first order correspond to first multiple-item-multiple-quantity orders that do not include only items placed within the preset item picking zones and do not include the same item types.

In the case of the nineteenth order, it includes five units of item A and five units of item D. Accordingly, the picking worker needs to pick five units of item A in the first item picking zone and load them onto the item transport robot 20, and pick five units of item D in the second item picking zone and load them onto the item transport robot 20.

In the case of the twentieth order, it includes three units of item A, two units of item E, and two units of item F. Accordingly, the picking worker needs to pick three units of item A in the first item picking zone and load them onto the item transport robot 20, and pick two units of item E and two units of item F in the second item picking zone and load them onto the item transport robot 20.

In addition, in the case of the twenty-first order, it includes four units of item B and three units of item G. Accordingly, the picking worker needs to pick four units of item B in the first item picking zone and load them onto the item transport robot 20, and pick three units of item G in the third item picking zone and load them onto the item transport robot 20.

As such, in the case of the nineteenth order through the twenty-first order, since they do not include only items placed within the preset item picking zones and do not include the same item types, the movement path of the item transport robot 20 is relatively long by default, and the picked items do not share common characteristics. Accordingly, if the items included in the nineteenth order through the twenty-first order are picked together and loaded onto the item transport robot 20 at once without distinguishing between the orders, the overall order processing time becomes significantly longer because the picking worker takes a long time to pick the items due to the long movement path of the item transport robot 20, and the packing worker also requires a long time to sort the items by order for packing, since the picked items do not share common characteristics.

Accordingly, in the case of first multiple-item-multiple-quantity orders, such as the nineteenth order through the twenty-first order, which do not include only items placed within the preset item picking zones and do not include the same item types, the processor 300 may preferably determine the picking type of such first multiple-item-multiple-quantity orders as multi-order picking, in terms of improving order processing efficiency.

Meanwhile, the processor 300 may classify, as second multiple-item-multiple-quantity orders, those among the multiple-item-multiple-quantity orders selected in step S200 in which the quantity of items for all item types included in each multiple-item-multiple-quantity order exceeds the preset item quantity (S330). For example, the quantity of items for all item types included in the twenty-second order shown in FIG. 7 is 40, that of the twenty-third order is 50, and the total quantity of items included in the twenty-fourth order is 35. Each of these orders corresponds to a second multiple-item-multiple-quantity order in which the quantity exceeds a preset item quantity (e.g., 30).

Such second multiple-item-multiple-quantity orders have a relatively large total quantity of items, and therefore, once the items included in one of the second multiple-item-multiple-quantity orders are loaded onto the item transport robot 20, it is highly likely that the items included in another second multiple-item-multiple-quantity order cannot be loaded onto the item transport robot 20.

Furthermore, even if the items included in at least two of the second multiple-item-multiple-quantity orders are picked together, if the picking type is total picking, an excessively large number of items become mixed together, causing the packing worker to spend too much time separating the items by order. In addition, even if the items included in at least two of the second multiple-item-multiple-quantity orders are picked together, if the picking type is multi-order picking, the picking worker must pick a very large number of items while distinguishing them by order, which results in excessive time spent on picking the items. That is, if the picking worker picks the items included in at least two of the second multiple-item-multiple-quantity orders together during the picking operation, it may rather reduce the order processing efficiency.

Accordingly, for the second multiple-item-multiple-quantity orders classified in step S330, it is desirable that the processor 300 determines the picking type to be a picking type in which the picking worker picks only the items included in a single second multiple-item-multiple-quantity order during the picking operation (in the present specification, such a picking type is referred to as “single-order picking”) (S331). Here, that the picking worker picks only the items included in a single second multiple-item-multiple-quantity order during the picking operation means that the picking worker collects only the items included in one second multiple-item-multiple-quantity order during the picking operation (for example, by loading all the items included in a single second multiple-item-multiple-quantity order onto one or more item transport robots 20).

As such, when the processor 300 determines the picking type of the second multiple-item-multiple-quantity orders to be single-order picking, the picking worker may load the items included in the twenty-second order (15 units of item C, 15 units of item D, and 10 units of item H) onto one or more item transport robots 20, load the items included in the twenty-third order (20 units of item D and 30 units of item I) onto another one or more item transport robots 20, and load the items included in the twenty-fourth order (10 units of item F, 15 units of item G, and 20 units of item I) onto yet another one or more item transport robots 20.

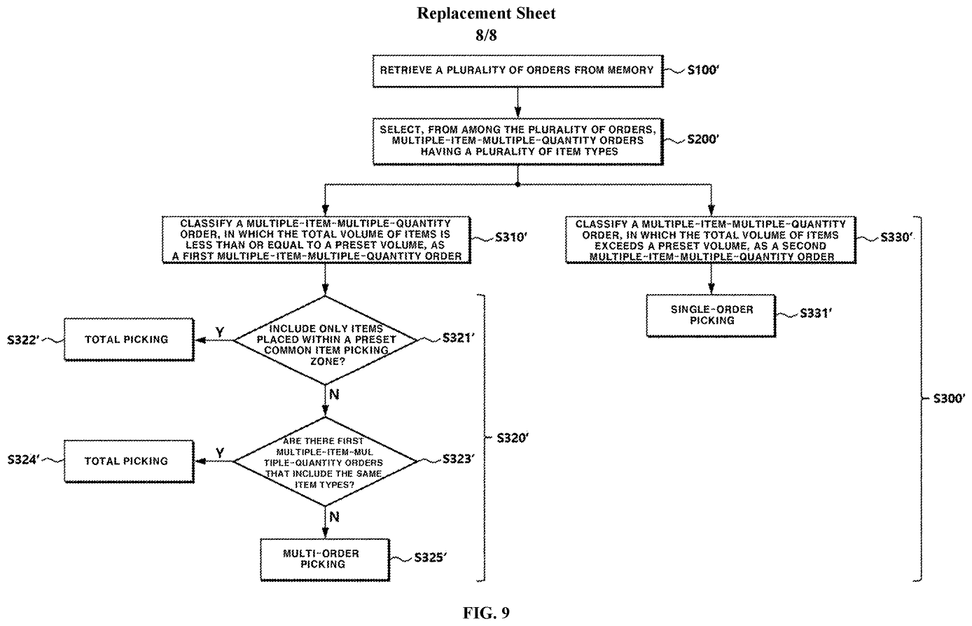

Meanwhile, FIG. 9 is a second embodiment of a method by which the processor 300 of FIG. 1 determines a picking type. The second embodiment of FIG. 9 differs from the first embodiment of FIG. 3 only in that the picking type is determined based on the total volume of all items included in each first multiple-item-multiple-quantity order, instead of the quantity of all item types included therein. Accordingly, the following description will focus on the aspects that differ, and unless directly inconsistent with the second embodiment, the details described above with respect to the first embodiment may equally apply to the second embodiment.

According to the second embodiment of the present disclosure, the processor 300 may first retrieve a plurality of orders from the memory 200 (S100′). More specifically, the processor 300 may request the plurality of orders from the memory 200, and in this case, the memory 200 may deliver the plurality of orders to the processor 300.

Subsequently, the processor 300 may select, from among the plurality of orders retrieved from the memory 200 (for example, the first to twenty-fourth orders), the multiple-item-multiple-quantity orders having a plurality of item types (for example, the seventh order to twenty-fourth order) (S200′). This is to efficiently process the multiple-item-multiple-quantity orders, as the item types and quantities included in such orders vary widely.

Subsequently, the processor 300 may determine a picking type for each of the multiple-item-multiple-quantity orders selected in step S200′ by considering the total volume of the items included in the respective multiple-item-multiple-quantity order (S300′).

Step S300′ may be subdivided into step S310′, step S320′, and step S330′.

First, in step S310′, the processor 300 may classify, as first multiple-item-multiple-quantity orders, those among the multiple-item-multiple-quantity orders selected in step S200′ in which the total volume of the items included in each multiple-item-multiple-quantity order is less than or equal to a preset volume (S310′).

The warehouse management server 10 may store the volume of each individual item and, upon request from the communicator 100, may transmit the volume of the individual item to the communicator 100. In this case, the processor 300 may receive the volume of each individual item through the communicator 100 and calculate the total volume of the items included in each multiple-item-multiple-quantity order by multiplying the quantity of items included in each multiple-item-multiple-quantity order by the volume of the individual item.

As another example, the memory 200 may have the volume of each individual item pre-stored therein. Accordingly, the processor 300 may retrieve the volume of each individual item from the memory 200 and calculate the total volume of the items included in each multiple-item-multiple-quantity order by multiplying the quantity of items included in each multiple-item-multiple-quantity order by the volume of the individual item.

The processor 300 may, after calculating the total volume of the items included in each multiple-item-multiple-quantity order, determine whether the total volume of the items is less than or equal to a preset volume. Here, the preset volume may be stored in the memory 200, and the processor 300 may retrieve the preset volume from the memory 200 when performing step S310′. For example, the preset volume may correspond to 50% of the total volume that can be loaded onto a single item transport robot 20. In addition, the preset volume may be variously modified and implemented as needed.

Referring again to FIGS. 6 and 7, the processor 300 may classify, as first multiple-item-multiple-quantity orders, those multiple-item-multiple-quantity orders in which the total volume of the items included is less than or equal to a preset volume, such as the seventh order to twenty-first order.

Subsequently, the processor 300 may determine the picking type of the first multiple-item-multiple-quantity orders, classified in step S310′, as a picking type in which the picking worker picks items included in at least two of the first multiple-item-multiple-quantity orders together during the picking operation (S320′).

As described above, even if the item transport robot 20 has sufficient space to accommodate more items, when the item transport robot 20 is configured to load only the items included in a single order, the order processing efficiency may inevitably be very low.

Furthermore, if the total volume of the items included in a certain multiple-item-multiple-quantity order is relatively small, and even when the item transport robot 20 loads the items included in the certain order, the item transport robot 20 is still capable of sufficiently loading items included in another order, it is desirable, in terms of improving order processing efficiency, for the item transport robot 20 to process two or more orders simultaneously.

For example, compared to the case where only the items included in the seventh order are loaded onto a single item transport robot 20, if the items included in the seventh order, the eighth order, and the ninth order are all loaded onto a single item transport robot 20, the item transport robot 20 effectively processes three orders simultaneously, thereby significantly improving order processing efficiency. Accordingly, for each of the first multiple-item-multiple-quantity orders in which the total volume of items is less than or equal to a preset volume (for example, the seventh order to twenty-first order), it is desirable for the processor 300 to determine the picking type as a picking type in which the picking worker picks items included in at least two of the first multiple-item-multiple-quantity orders together during the picking operation.

As described above, the picking types in which the items included in at least two of the first multiple-item-multiple-quantity orders are picked together include total picking and multi-order picking. Accordingly, the processor 300 may subdivide step S320′ and determine a more suitable picking type between total picking and multi-order picking based on the characteristics of each order.

For example, the seventh order, the eighth order, and the ninth order each include only items placed in a first item picking zone, and the tenth order, the eleventh order, and the twelfth order each include only items placed in a second item picking zone. In addition, the thirteenth order, the fourteenth order, and the fifteenth order each include only items placed in a third item picking zone.

As such, when at least two first multiple-item-multiple-quantity orders include only items that are arranged within a preset item picking zone (for example, the first item picking zone, the second item picking zone, or the third item picking zone), the picking worker may pick the items arranged in the item picking zone together without distinguishing between the orders and load them onto the item transport robot 20. For example, when the item transport robot 20 is positioned at the first station 31, the picking worker may pick the items included in the seventh order through the ninth order—namely, a total of 8 units of item A, 7 units of item B, and 10 units of item C—together and load them onto the item transport robot 20.

As such, when the picking worker does not distinguish between orders during the picking operation, the picking time for the items can be significantly reduced. Of course, in this case, the packing worker must sort and pack the picked items by order (for example, by the seventh order, eighth order, and ninth order). However, since only the items arranged within a common item picking zone (for example, item A, item B, and item C) are transferred to the packing table by the item transport robot 20, it does not take much time for the packing worker to sort the picked items by order. That is, even when considering the time required for the packing worker to sort the picked items by order, the overall order processing time can be reduced in view of the reduced picking time for the picking worker.

In this regard, after step S310′, the processor 300 may determine whether there is any first multiple-item-multiple-quantity order among the first multiple-item-multiple-quantity orders that includes only items arranged within a preset item picking zone (S321′).

When the processor 300 determines in step S321′ that there is a first multiple-item-multiple-quantity order among the first multiple-item-multiple-quantity orders that includes only items arranged within the preset item picking zone, the processor 300 may determine the picking type of such first multiple-item-multiple-quantity orders (for example, each of the seventh order through the fifteenth order) as total picking (S322′), thereby improving the efficiency of order processing.

In contrast, when the processor 300 determines in step S321′ that a first multiple-item-multiple-quantity order among the first multiple-item-multiple-quantity orders does not include only items arranged within the preset item picking zone (for example, the sixteenth order through the twenty-first order), the processor 300 may perform step S323′ with respect to such orders.

Referring again to FIG. 7 in connection with step S323′, the sixteenth order through the eighteenth order each include the same item types, namely item A, item E, and item I.

As described above, if the picking worker processes the sixteenth order through the eighteenth order individually, three picking operations are performed in each of the first item picking zone, second item picking zone, and third item picking zone, respectively. Considering the movement path of the item transport robot 20, this increases the order processing time and results in a decrease in order processing efficiency.

In contrast, when the picking worker picks a total of eight units of item A in the first item picking zone and loads them onto the item transport robot 20, picks a total of nine units of item E in the second item picking zone and loads them onto the item transport robot 20, and picks a total of eleven units of item I in the third item picking zone and loads them onto the item transport robot 20, the item transport robot 20 can process the sixteenth order through the eighteenth order simultaneously by being positioned at each of stations 31, 32, and 33 only once. That is, in this case, the order processing time is significantly reduced, thereby improving the order processing efficiency.

In this case, the picking worker can pick the items included in the sixteenth order, seventeenth order, and eighteenth order from each item picking zone without necessarily distinguishing between the orders.

As described above, when the picking worker does not distinguish between orders during the picking operation, the picking time for the items can be significantly reduced. Of course, in this case, the packing worker must sort and pack the picked items by order (for example, by the sixteenth order, seventeenth order, and eighteenth order). However, since the same item types (for example, item A, item E, and item I) are transferred to the packing table, it does not take much time for the packing worker to sort the picked items by order. That is, even when considering the time required for the packing worker to sort the picked items by order, the overall order processing time can be reduced in view of the reduced picking time for the picking worker.

In this regard, after step S321′ (or step S322′), the processor 300 may determine whether there are first multiple-item-multiple-quantity orders among the first multiple-item-multiple-quantity orders that include the same item types (S323′).

When, as a result of the determination in step S323′, there are first multiple-item-multiple-quantity orders including the same item types, the processor 300 may determine the picking type of such first multiple-item-multiple-quantity orders (e.g., the sixteenth order, seventeenth order, and eighteenth order, respectively) as total picking (S324′), thereby improving order processing efficiency.

In contrast, when, as a result of the determination in step S323′, the first multiple-item-multiple-quantity orders do not include the same item types, the processor 300 may determine the picking type of such orders as multi-order picking (S325′).

For example, since the nineteenth order through the twenty-first order do not include only items placed within the preset item picking zones and do not include the same item types, the movement path of the item transport robot 20 is relatively long by default, and the picked items do not share common characteristics.

Accordingly, if the items included in the nineteenth order through the twenty-first order are picked together and loaded onto the item transport robot 20 at once without distinguishing between the orders, the overall order processing time becomes significantly longer because the picking worker takes a long time to pick the items due to the long movement path of the item transport robot 20, and the packing worker also requires a long time to sort the items by order for packing, since the picked items do not share common characteristics.

Accordingly, in the case of first multiple-item-multiple-quantity orders, such as the nineteenth order through the twenty-first order, which do not include only items placed within the preset item picking zones and do not include the same item types, the processor 300 may preferably determine the picking type of such first multiple-item-multiple-quantity orders as multi-order picking, in terms of improving order processing efficiency.

Meanwhile, the processor 300 may classify, as second multiple-item-multiple-quantity orders, those among the multiple-item-multiple-quantity orders selected in step S200′ in which the total volume of items included in each multiple-item-multiple-quantity order exceeds the preset volume (S330′). For example, the twenty-second order, the twenty-third order, and the twenty-fourth order of FIG. 7 each correspond to a second multiple-item-multiple-quantity order that exceeds a preset volume.

Such second multiple-item-multiple-quantity orders have a relatively large total volume of items, and therefore, once the items included in one of the second multiple-item-multiple-quantity orders are loaded onto the item transport robot 20, it is highly likely that the items included in another second multiple-item-multiple-quantity order cannot be loaded onto the item transport robot 20.

Furthermore, even if the items included in at least two of the second multiple-item-multiple-quantity orders are picked together, if the picking type is total picking, the items, which have relatively large volumes, become mixed together, causing the packing worker to spend too much time separating the items by order. In addition, even if the items included in at least two of the second multiple-item-multiple-quantity orders are picked together, if the picking type is multi-order picking, the picking worker must pick the items with relatively large volumes while distinguishing them by order, which results in excessive time spent on picking the items. That is, picking the items included in at least two of the second multiple-item-multiple-quantity orders together may rather reduce the order processing efficiency.

Accordingly, for the second multiple-item-multiple-quantity orders classified in step S330′, it is desirable that the processor 300 determines the picking type to be single-order picking, that is, a picking type in which the picking worker picks only the items included in a single second multiple-item-multiple-quantity order during the picking operation (S331′).

As such, when the processor 300 determines the picking type of the second multiple-item-multiple-quantity orders to be single-order picking, the picking worker may load the items included in the twenty-second order (15 units of item C, 15 units of item D, and 10 units of item H) onto one or more item transport robots 20, load the items included in the twenty-third order (20 units of item D and 30 units of item I) onto another one or more item transport robots 20, and load the items included in the twenty-fourth order (10 units of item F, 15 units of item G, and 20 units of item I) onto yet another one or more item transport robots 20.

As described above, although the present disclosure has been described with reference to limited embodiments and drawings, the present disclosure is not limited to the above embodiments, and various modifications and variations may be made by those of ordinary skill in the art based on the above description.

For example, although the above description assumes that the items picked by the picking worker are transferred to the packing table while being loaded on the item transport robot 20, the picked items may instead be transferred to the packing table while being loaded on another transport means such as a forklift, a cart, or something other than the item transport robot 20. In some cases—such as when the quantity of all item types included in the order is small or the total volume of the items included in the order is low—the picking worker may carry the items directly to the packing table.

In addition, although the description of the first embodiment above explains that the processor 300 performs step S323 after step S321, it is also possible to perform step S321 after step S323. In addition, although the description of the second embodiment above explains that the processor 300 performs step S323′ after step S321′, it is also possible to perform step S321′ after step S323′. Accordingly, the technical spirit of the present disclosure should be understood only by the scope of the claims, and all equivalents or equivalent modifications thereof shall be construed as falling within the scope of the technical spirit of the present disclosure.

What is claimed is:

1. An order-based picking type determination apparatus, comprising:
a memory configured to store at least one instruction for determining a picking type based on an order, a plurality of orders, and a preset item quantity to determine different picking types for each multiple-item-multiple-quantity order according to a item quantity of all item types included in each multiple-item-multiple-quantity order; and
a processor configured to execute the at least one instruction stored in the memory,
wherein the processor is configured to:
retrieve the plurality of orders from the memory;
select, from among the plurality of orders retrieved from the memory, multiple-item-multiple-quantity orders having a plurality of item types;
retrieve the preset item quantity from the memory;
classify, as first multiple-item-multiple-quantity orders, multiple-item-multiple-quantity orders in which the item quantity of all item types included therein is less than or equal to the preset item quantity;
determine, for each of the first multiple-item-multiple-quantity orders, a picking type in which a picking worker picks the items included in at least two of the first multiple-item-multiple-quantity orders together during a picking operation;
classify, as second multiple-item-multiple-quantity orders, multiple-item-multiple-quantity orders in which the item quantity of all item types included therein exceeds the preset item quantity; and
determine, for each of the second multiple-item-multiple-quantity orders, a picking type in which a picking worker picks only the items included in a single second multiple-item-multiple-quantity order during a picking operation.

2. The order-based picking type determination apparatus of claim 1, wherein the processor is configured to:
determine, as a picking type for a first multiple-item-multiple-quantity order among the first multiple-item-multiple-quantity orders that includes only items placed in a preset item picking zone, a picking type in which a picking worker picks the items without distinguishing between orders during a picking operation.

3. The order-based picking type determination apparatus of claim 1, wherein the processor is configured to:
determine, as a picking type for a first multiple-item-multiple-quantity order among the first multiple-item-multiple-quantity orders that includes the same item types, a picking type in which a picking worker picks the items without distinguishing between orders during a picking operation.

4. The order-based picking type determination apparatus of claim 1, wherein the processor is configured to:
determine, as a picking type for a first multiple-item-multiple-quantity order among the first multiple-item-multiple-quantity orders that does not include only items placed in a preset item picking zone and does not include same item types, a picking type in which a picking worker picks the items while distinguishing between orders during a picking operation.

5. An order-based picking type determination apparatus, comprising:
a memory configured to store at least one instruction for determining a picking type based on an order, a plurality of orders, and a preset item volume to determine different picking types for each multiple-item-multiple-quantity order according to a total volume of items included in each multiple-item-multiple-quantity order; and
a processor configured to execute the at least one instruction stored in the memory,
wherein the processor is configured to:
retrieve the plurality of orders from the memory;
select, from among the plurality of orders retrieved from the memory, multiple-item-multiple-quantity orders having a plurality of item types;
retrieve the preset item volume from the memory;
classify, as first multiple-item-multiple-quantity orders, multiple-item-multiple-quantity orders in which the total volume of items included therein is less than or equal to the preset item volume;
determine, for each of the first multiple-item-multiple-quantity orders, a picking type in which a picking worker picks the items included in at least two of the first multiple-item-multiple-quantity orders together during a picking operation;
classify, as second multiple-item-multiple-quantity orders, multiple-item-multiple-quantity orders in which the total volume of items included therein exceeds the preset item volume; and
determine, for each of the second multiple-item-multiple-quantity orders, a picking type in which a picking worker picks only the items included in a single second multiple-item-multiple-quantity order during a picking operation.

6. The order-based picking type determination apparatus of claim 5, wherein the processor is configured to:
determine, as a picking type for a first multiple-item-multiple-quantity order among the first multiple-item-multiple-quantity orders that includes only items placed in a preset item picking zone, a picking type in which a picking worker picks the items without distinguishing between orders during a picking operation.

7. The order-based picking type determination apparatus of claim 5, wherein the processor is configured to:
determine, as a picking type for a first multiple-item-multiple-quantity order among the first multiple-item-multiple-quantity orders that includes the same item types, a picking type in which a picking worker picks the items without distinguishing between orders during a picking operation.

8. The order-based picking type determination apparatus of claim 5, wherein the processor is configured to:
determine, as a picking type for a first multiple-item-multiple-quantity order among the first multiple-item-multiple-quantity orders that does not include only items placed in a preset item picking zone and does not include same item types, a picking type in which a picking worker picks the items while distinguishing between orders during a picking operation.
